(19) United States
(12) Patent Application Publication
(10) Pub. No.: US 2006/0085309 A1
(43) Pub. Date: Apr. 20, 2006

(54) SYSTEMATIC EXPANSION OF LEVERAGED FINANCING

(76) Inventor: DEREK TAMURA, HONOLULU, HI (US)

Correspondence Address: D. T. SERVICES, P. O. BOX 240989, HONOLULU, HI, 96824, US

(21) Appl. No.: 10/711,967

(22) Filed: Oct. 15, 2004

(51) Int. Cl. G06Q 40/00

(52) U.S. Cl. 705/35; 705/38

(57) ABSTRACT

The method and process of the invention calculates a budget that systematically pays off debts at an accelerated rate without a need to increase the cash flow volume or cause budget cuts while expanding the budget's disposable income. The method requires a budget's entire cash flow income to be paid to a cash flow leveraging mechanism prior to any expense or debt payments resulting in substantially greater profits than accelerated loan payment programs demonstrating savings on total interest costs. The invention is affordable, cost effective, detailed, accurate and provides a realistic and simple to follow budget plan.

The Systematic Expansion of Leveraged Financing method, hereinafter SELF, uses five unique mechanisms to define an accelerated loan payment program that precisely calculates each extra payment amount and extra payment date of future extra payments made to debt(s) targeted for accelerated pay off. A floating payment method calculates unfixed payment amounts paid on the dates calculated to be affordable to the current budget. The method realizes significantly greater hard profits on the front end than programs featuring total interest costs savings provided on the back end.

### RELATED APPLICATIONS

Cross reference to related applications.

| Patent Number | Date | Name |
|---|---|---|
| 3634669 | January, 1972 | Soumas. |
| 3697693 | October, 1972 | Deschenes. |
| 4334270 | June, 1982 | Towers. |
| 4346442 | August, 1982 | Musmanno. |
| 4376978 | March, 1983 | Musmanno. |
| 4597046 | June, 1986 | Musmanno. |
| 4642767 | February, 1987 | Lerner. |
| 4722055 | January, 1988 | Roberts. |
| 4742457 | May, 1988 | Leon. |
| 4752877 | June, 1988 | Musmanno. |
| 4774663 | September, 1988 | Musmanno. |
| 4739478 | April, 1988 | Roberts et al. |
| 5058009 | October, 1991 | Yoshino et al. |
| 5673402 | September, 1997 | Ryan et al. |
| 5689649 | November, 1997 | Altman et al. |
| 5878404 | March, 1999 | Stout, Jr. et al. |
| 6269347 | Jul., 20001 | Berger |

### TERMINOLOGY UNIQUE TO THE FIELD OF THE INVENTION

Terminology to understanding the details of the invention.

Definition List 1

| Term | Definition |
|---|---|
| Accelerated loan | Any method that adds payments to a loan |
| payment, repayment | contract for the purpose of paying off the loan |
| method | ahead of the contracted retirement date. |
| Back End | The time when profits are realized in |
| | comparison to the start (front end) or end |
| | (back end) of a contract or program. |
| Biweekly, bimonthly | Also monthly, quarterly, semiannual, annually |
| | intervals used to schedule loan payments on a |
| | consistent and recurring basis |
| Cash Allocation | Any account or device that temporarily holds |
| Account, checking | funds allocated for expenses then makes |
| account, bill payment | payments to those expenses as it becomes |
| account, cash | payable or due. |
| distribution account | |
| Cash Income | Any source of income that increases the net |
| Account, income, | balance of a budget. |
| earnings | |
| Client Data | Past, present and projected budget |
| | information. |
| Cash Augmenting | Any bank or bank like product or service that |
| Account, leveraged | is able to hold a cash reserve, allows funds to |
| financing | be paid into or out of the account, allows |
| mechanism, cash | transactions to occur as needed by a client, |
| reserve account, cash | allows electronic draw or payments and does |
| leveraging account, | not limit the number of transactions. |
| leveraging account | |
| Expansion | Continual growth. |
| Extra payments | The added payment amounts that are not part |
| | of the loan contract but used to accelerate |
| | loan payment. |
| Financing | To pay for, arrange to pay for or cover costs. |
| Front End | The time when profits are realized in |
| | comparison to the start (front end) or end |
| | (back end) of a contract or program. |
| Leveraged | The use of a device or mechanism that |
| | amplifies efforts. |
| Principal only | The extra payments that are a payment with |
| payments | specific instructions to the loan service agent |
| | that the amount not have any portion credited |
| | to interest but the entire amount be applied |
| | to any remaining balance of the loan principal. |
| Profit | The cash amount in excess of expenses. |
| Savings | The potential. |
| Systematic | Routine, logical, efficient, organized or |
| | methodical. |
| Target Debt, target | Any installment type loan that will apply, is |
| loan, target | applying or has applied an accelerated loan |
| | payment method. |

### BACKGROUND OF THE INVENTION

The more popular accelerated loan payment methods combine regular scheduled loan payments, as defined by the loan contract, with extra payments specifically directed towards the loan principal. Those extra payments are fixed amounts scheduled at consistent intervals such as weekly, bi-weekly, bimonthly, monthly, quarterly, semi-annual or annual payments and dependent on regular cash allocations from an existing budget. To make the extra payments affordable the budget considers increased income or cutting expenses. If current cash flow prohibits extra payments when due then the accelerated loan payment method in use is inconsistent and unaffordable.

The affordability of accelerated loan payments is assured when a) the restrictions of fixed extra payments at regularly scheduled intervals are eliminated; b) extra payments are paid only when the payments are affordable; c) increasing income is not necessary; and d) extra payments amounts do not require budget cuts or re-allocation.

Current accelerated loan payment programs are designed for mortgages and propose substantial savings on overall interest costs for installment type loans. Significantly greater profits are realized in a shorter periods of time by focusing on eliminating the total number of payments actually being paid to one or more installment loan contract(s) such as credit cards, personal loans, auto loans, medical loans, student loans, 2^{nd} mortgages, business loans, lines of credit, negotiated tax payments, court ordered payments etc.

A more effective and thereby more profitable accelerated loan payment program factors in each type of installment payment debts and focuses on the total debt load, more specifically, eliminating the total number and amount of debt service payments.

More recently developed methods of accelerated loan payment methods use home equity lines of credit to facilitate accelerated loan pay off by using cash advances to make the extra payments. The set up costs may include appraisal fees and credit checks. This type of method only affords participation from mortgages that have available equity and, in practice, does not produce an accurate loan repayment schedule thereby creating financial planning ambiguities. Piggybacking home equity lines of credit with accelerated loan repayment remains vague, imprecise and the lacks the consistency needed to create a credible financial plan.

Consistency is attained by creating a budget that accurately a) defines income, expenses and debt service b) defines extra payment amounts, dates of payments and source of payments; c) accounts for fluctuations in income and expense; and d) easily provides updated details of a, b and c for any required period.

Professional groups that regularly seek financing for various projects must develop budget plans of high integrity and accuracy. This process first collects and analyzes historical, current and projected data related to the working environment of a specific project. Then a model of the project is developed that included details of projected cash flow, costs and profitability over a specific periods of time. The model's flexibility allows re-evaluation and revisions to accommodate changes in historical, current and projected data. The consumption of time and expert man-hours to create a budget plan makes this method extremely costly.

Managing costs to create an accurate, detailed and feasible budget plan is possible by using specialized software that analyzes, evaluates and processes relevant data to produce a detailed plan that is easily updated and revised.

The consumer, commercial, industrial and institutional markets would greatly benefit from an accelerated loan payment method that solves the aforementioned affordability, consistency, costs, profits and planning issues. The SELF method solves those problems using five unique mechanisms that works within the parameters of an existing budget, is detailed to simplify application, precisely defines payment amounts and dates to eliminate guesswork, accurately projects future transactions to facilitate financial planning and is flexible enough to allow various degrees of budget modifications for unplanned financial events.

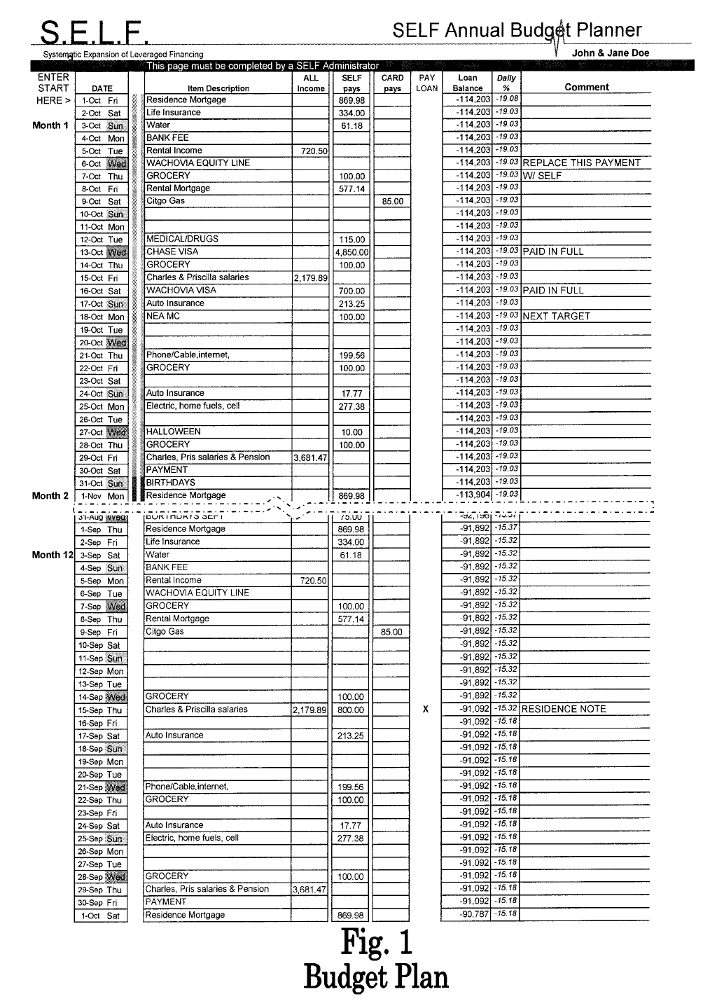

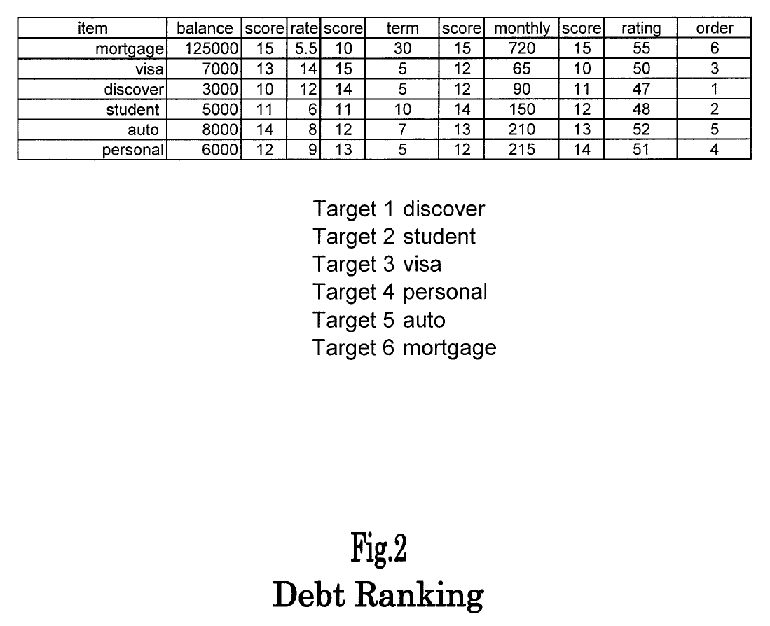

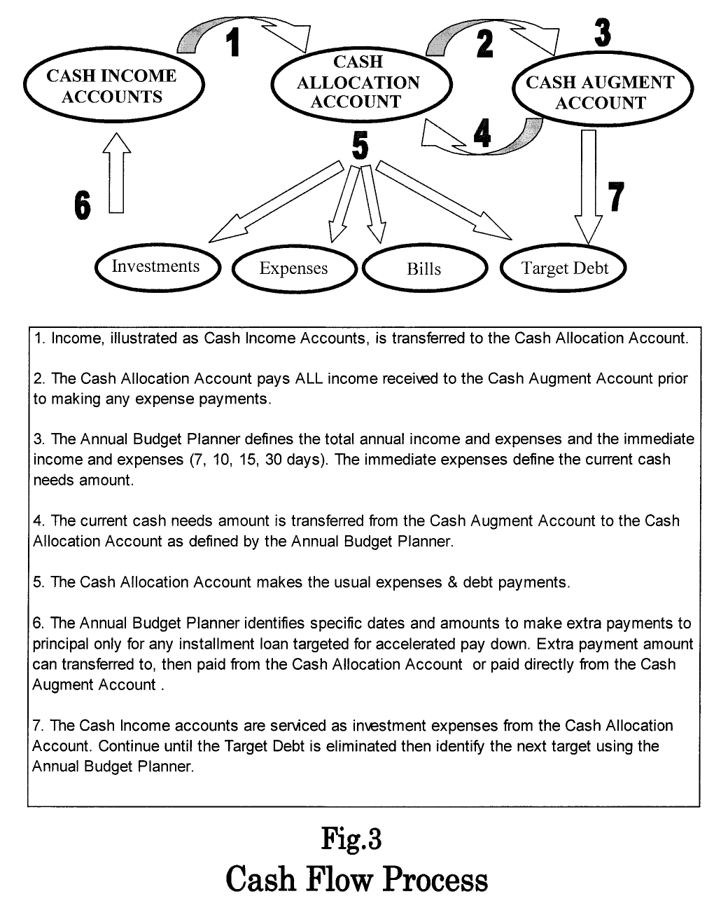

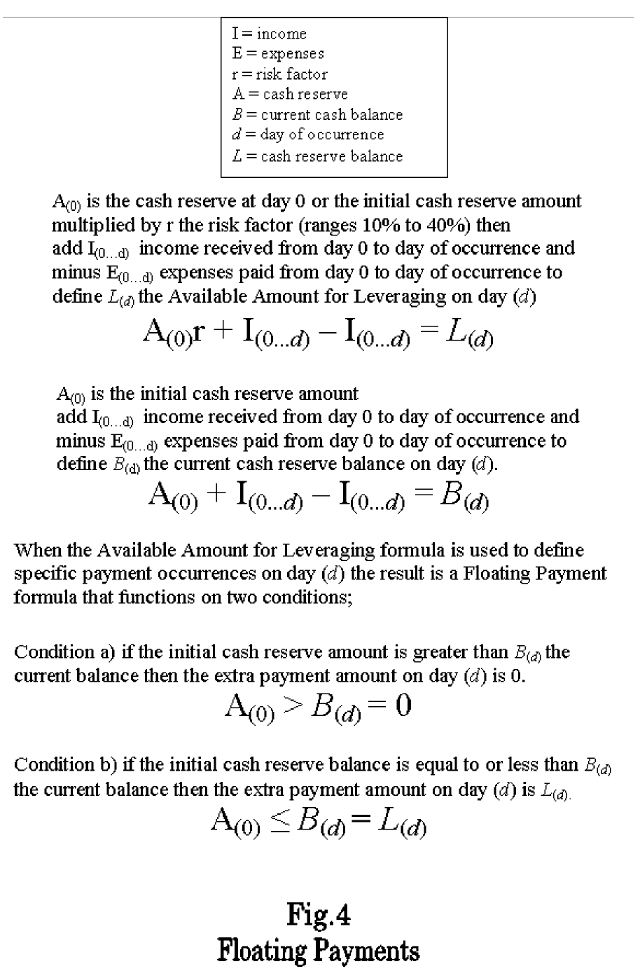

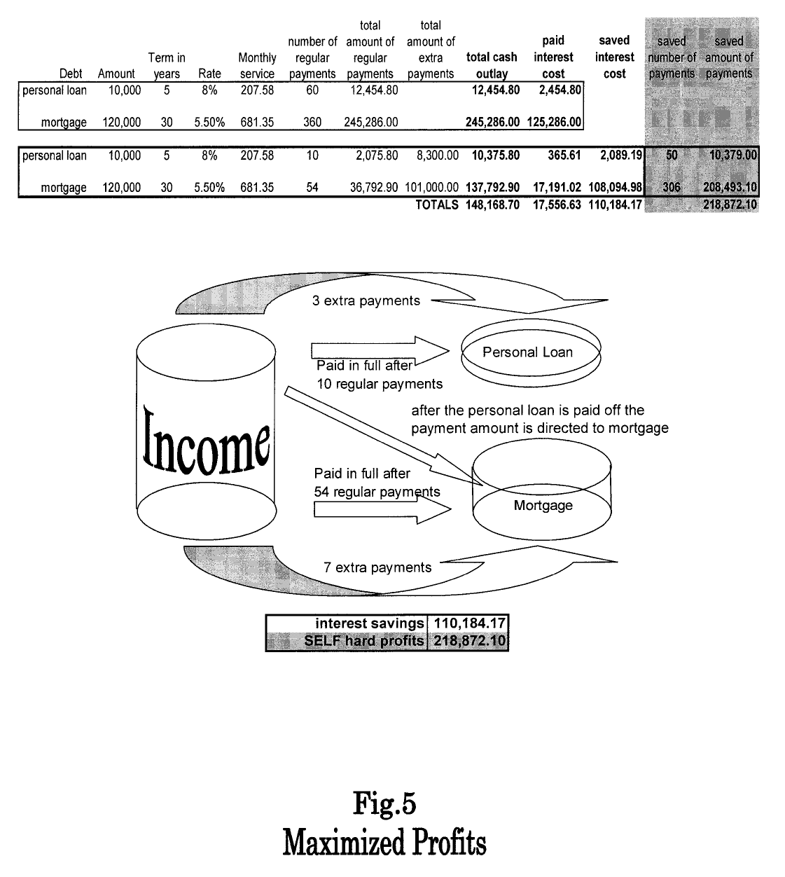

The invention method and process is defined as a Systematic Expansion of Leveraged Financing method. A client applies the SELF method using five unique and proprietary mechanisms in a seven step process:
(1) Client provides details of past, present and projected cash flow and debt load
(2) Initial review qualifies client's budget
(3) SELF method ranks debt(s)for elimination (FIG. 2)
(4) SELF method analysis to maximize profits (FIG. 5)
(5) SELF method use of leveraged and floating payments (FIG. 4)
(6) SELF method budget(s) options of 1 day to 50+ years (FIG. 1)
(7) SELF method cash flow applied by the client (FIG. 3)
   Step 1

Step 1 assumes the client receives income from one or more sources, hereinafter Cash Income Accounts, and puts all or most of that income into a bank or bank-like holding account for expense payments, hereinafter Cash Allocation Account. Client data is entered into a computer spreadsheet program. Client data entry is composed of detailed accounting of the client's past, present and projected cash flow and debt load including special financial events as income or expense entries. The special financial events may include expenses such as birthdays, holidays, anniversaries, vacation, seasonal, medical costs etc. and income such as dividends, distributions, inheritance, salary bonus, awards etc. In addition to traditional cash flow data, the SELF method demands a detailed daily accounting of income and expenses for at least a thirty day time period.

Step 2

Step 2 assumes the client has at least one installment loan type of debt with a remaining balance. Data from step 1 is processed using a spreadsheet program to determine if the client's annual income exceeds annual expenses. Income exceeding expenses and the ability to create a leveraging account are the minimal requirements to participate.

Step 3

SELF method's unique software compares and ranks current debt(s) then selects the most effective order to eliminate each debt at an accelerated rate (FIG. 2). Each debt is ranked by a) the balance remaining; b) the annual rate and the required debt service payments; c) the term in years; and d) the monthly debt service amount. The order that the debt(s) are targeted for accelerated elimination is defined with final target debt discretion to the client.

Example: The highest monthly payment is rated 15, next highest is 14, next highest is 13 and so on. The highest remaining balance is rated 15, next highest 14, next highest 13 and so on.

Step 4

The SELF method's unique software is used to develop accurate projections of different budget scenarios within the clients existing cash flow and debt service. Calculated projections of each budget version include current budget items and the associated time frames, allowances for fluctuations in cash flow, prepayment penalties, added or reduced costs, and regular and/or extra payments already made to the targeted debt.

Step 5

The client is required to create a cash flow leveraging mechanism, hereinafter the Cash Augmenting Account, in an institution of client's choice. The Cash Augmenting Account may use any bank or bank like product or service that allows the accumulation of cash and offers daily access to the account with no limits to the number of transactions paying into or out of the account.

The Cash Augmenting Account is a cash reserve with available funds determined by the needs of each client. The average cash reserve is 10,000. The ideal cash reserve amount is calculated by analyzing the client's budget then averaging the two months having the greatest total of monthly expenses and doubling that monthly average.

Example. April's expenses=7000, Decembers expenses=5000, Avg.=6000. The ideal amount of cash held in reserve in the Cash Augmenting Account is 12000.

The preferred leveraging account has no qualification, set up, maintenance or interest costs. If this type of account is not available to the client, other bank or bank like product or services that meet the criteria for use as a leveraging account are listed in the order of profitability:

SELF compatible accounts
Savings/holding account
Business line of credit
Money market account
Margin account
Personal line of credit

Note: Many accelerated loan payment programs highlight the use of a home equity line of credit (HELOC) to take advantage of accrued equity in a home and tax deductible interest costs. The however there are negative considerations such as: a) qualifying costs; b) set up costs; c) appraisal fees; d) negligible interest benefits; and e) limits on methods of cash draw (no electronic transfer).

The SELF method applies a floating payment method (FIG. 4) to the Cash Augmenting Account and precisely calculates and defines the date and amount that extra payments are made towards the target principal.

The floating payment method analyzes daily budget transactions and identifies each day that the client's accrued income to date exceeds the accrued expenses to date. The daily amount that exceeds the daily expenses is disposable cash that accumulates in the cash reserve or Cash Augmenting Account.

Example: The initial cash reserve of an Augmenting Account is +10,000.

| Date_{(d)} | Income | Expense | Cash reserve |
|---|---|---|---|
| Day 1 | 0 | 0 | +10,000 |
| Day 2 | 0 | −400 | +9,600 |
| Day 3 | +600 | −100 | +10,100 |
| Day 17 | +100 | 0 | +10,000 |

The accumulation is automatic by paying all income to the Cash Augmenting Account prior to any expense payments as illustrated by item 2 in the Cash Flow Process (FIG. 3).

Step 6

The client is provided with one or more precise, accurate, detailed and feasible budget plan(s). Each budget's time frame is customized to fit the client's needs and can be a single day or 50+ years. Typically the client uses a one year budget (FIG. 1) and each budget version precisely defines each cash flow transaction date, description, amount, leveraged account usage, SELF fees (if any), target debt cost, target debt reduction and on a daily basis.

The SELF method uses a Risk Factor, determined by each client, which is a percentage of the minimum cash reserve or the initial cash reserve in calculating all extra payment amounts. Multiplying the Risk Factor by the initial cash reserve and adding the amount in excess of the initial cash reserve produces the cash amount available amount for leveraging. A higher Risk Factor provides more cash for leveraging and creates a more aggressive accelerated loan payment program by.

Example: A conservative Risk Factor is 20%. Day 3 The cash available for leveraging is 20% of 10,000+100 or 2,100.

| Date_{(d)} | Income | Expense | Cash reserve | |
|---|---|---|---|---|
| Day 3 | +600 | −100 | +10,100 | Current balance |
| | | | 10,000 | Initial |
| | | | ×20% | Risk factor |
| | | | | = 2,000 |
| | | | | Added to |
| | | | 10,100 | Current balance |
| | | | −10,000 | Initial |
| | | | | = 100 |
| | | | | = 2,100 |

Step 7

Step 7 of the SELF method combines aspects of the previous 6 steps to apply the complete SELF method.

The Cash Augmenting Account to enables four cash leveraging effects to enhance the client's cash flow; a) a cash draw greater than the current income is available to pay regular expenses as it becomes due; b) the cash reserve balance expands by accumulating income amounts not used for expenses; c) extra payments to targeted debt is partially or wholly financed at each instance the accumulated cash reserve is equal to or in excess of the initial cash reserve amount; d) extra payment amounts vary according to the amount of excess over the initial cash reserve amount.

The SELF method systematically replenishes the Cash Augmenting Account by paying all income to the Cash Augmenting Account prior to making any expense payments (FIG. 3).

Because the client's annual income exceeds the annual expenses (see step 2) there exists multiple future instances within the budget when the income amounts exceed expenses and adds to the cash reserve account balance. Additions to the cash reserve balance continues in a routine manner until the initial cash reserve amount is equaled or surpassed. At that moment the amount available for leveraging is calculated and is made available for an extra payment to the target loan (FIG. 4).

Example: Extra payments, self financed with a risk factor of 20%.

| Date_{(d)} | Income | Expense | Cash reserve | Extra Payment |
|---|---|---|---|---|
| Day 1 | 0 | 0 | +10,000 | −2,000 |
| Day 2 | 0 | −400 | +9,600 | 0 |
| Day 3 | +600 | −100 | +10,100 | −2,100 |
| Day 17 | +100 | 0 | +10,000 | −2,000 |

The SELF method systematically expands disposable income by targeting then quickly eliminating low rated debts. Funds formerly used to service the debt is disposable income available for other purposes, however, if it is used to replenish the Cash Augmenting Account the accelerated elimination of the remaining debt(s), if any, is greatly enhanced.

As more debts are retired, funds formerly used for debt service is potential profit made available as disposable income that can be used to further accelerate debt retirement, used for other purposes or taken as profit (FIG. 5).

The SELF method can be implemented before or during any stage of an installment loan. Using SELF extra payments to the target continue until the target debt is eliminated then a new target is set. The process continues until no debt remains leaving options to keep or eliminate the leveraging account.

What is claimed is:

1. A method that uses a precisely calculated working budget and cash flow leveraging mechanism to systematically accelerate debt pay off while expanding a budget's disposable income without a need to increase the budget cash flow income volume or cause budget cuts. The method requires the budget to immediately pay the entire cash flow income to the cash flow leveraging mechanism prior to any expense or debt payments in order to maximize the leveraging effects and produce substantially greater front end profits than programs demonstrating back end interest cost savings.

2. The method used in claim 1 uses specialized computer software to capture a budget's past, present and projected cash flow and debt load data for review, analysis and processing.

3. The method used in claim 1 uses specialized computer software to create one or more precise, accurate, detailed and feasible budget scenario(s) from which to work from (FIG. 1).

4. The method used in claim 1 uses specialized computer software to provide a print out of the any one or more of the working budget scenarios.

5. The method used in claim 1 systematically selects and targets each installment type loan for accelerated pay off in a specific order.

6. The method used in claim 1 ranks each debt to determine the selection of the first target debt and the order of each successive debt targeted for accelerated elimination.

7. The method used in claim 1 accelerates debt pay off by budgeting regular (current and future) debt service payments and the calculated (current and future) “to principal only” payments to targeted debt(s).

8. The method used in claim 1 further accelerates debt pay off by allocating funds, formerly used to service each retired debt, as disposable income available to add to principal only payments on remaining debts.

9. The method used in claim 1 expands a budget's disposable income by causing accelerated retirement of one or more target debts then, as each debt is retired, the funds formerly used to service each retired debt is disposable income available for other expenses.

10. The method used in claim 1 accelerates debt pay off and/or expands a budget's disposable income at the option of the budget operator.

11. The method used in claim 1 works without a need to increase a budgets cash flow income volume or causing budget cuts by using the working budget created from the specialized computer software.

12. The method used in claim 1 works without a need to increase cash flow income using the working budget which factors in existing cash flow restrictions, reallocating funds formerly used to service each retired debt and employing of a no cost or low cost cash flow leveraging mechanism.

13. The method used in claim 1 uses a cash flow leveraging mechanism that allows a budget to execute daily cash in or cash out transactions as often as needed. The preferred leveraging mechanism would have no service fees, set up costs or transfer restrictions and can be set up in a single day.

14. The method used in claim 1 may use cash flow leveraging mechanisms that are not limited to any bank or bank like product or service or traditional banking systems.

15. The method used in claim 1 works using a cash flow leveraging mechanism that, if not used, costs nothing, and if used, would serve to supplement the current cash flow by providing no cost or very low cost cash.

16. The method used in claim 1 works using a cash flow leveraging mechanism as a supplemental cash reserve with an initial cash reserve amount, the entire of which is available to be used by the budget.

17. The method used in claim 1 uses the cash flow leveraging mechanism to leverage a budget's cash flow and have funds available to pay regular expenses as the expense becomes due.

18. The method used in claim 1 works using a cash flow leveraging mechanism to leverage a budgets cash flow by having additional funds available for fluctuating income/expense or yet unknown financial events.

19. The method used in claim 1 requires the budget to immediately pay the entire cash flow income to the cash flow leveraging mechanism prior to expense/debt payments or cash out transactions.

20. The method used in claim 1 immediately pays the budget's to entire cash flow income to the cash flow leveraging mechanism to quickly reduce the time frame of any negative cash balance effects (interest charges).

21. The method used in claim 1 immediately pays the budget's to entire cash flow income to the cash flow leveraging mechanism to create an automatic and constantly replenishing effect of the account's cash reserve balance.

22. The method used in claim 1 uses the cash flow leveraging mechanism to accumulate nonperforming cash until the reserve is built or rebuilt from income not paid out to expenses.

23. The method used in claim 1 accumulates cash in the cash flow leveraging mechanism only until an even or positive balance is achieved.

24. The method used in claim 1 uses the even or positive balance of the cash flow leveraging mechanism to signal extra payment financing availability to accelerate pay off of target loans.

25. The method used in claim 1 uses the cash flow leveraging mechanism's even or positive balance with the floating payment formula (FIG. 4) to determine each future occurrence of principal only extra payments to target loan(s) that can be made without negatively affecting the working budget.

26. The method used in claim 1 uses the cash flow leveraging mechanism and the floating payment formula to calculate each principal only extra payment date. Calculated extra payments are available at every occurrence that income payments cause the cash reserve balance to match or exceed the initial cash reserve balance. Payment dates are precise and accurate and are not set at regularly scheduled intervals.

27. The method used in claim 1 uses the cash flow leveraging mechanism and the floating payment formula to calculate each principal only payment amount. Calculates extra payment amounts are available at every occurrence that income payments cause the cash reserve balance to match or exceed the initial cash reserve balance. Payment amounts are precise and accurate and are not fixed amounts.

28. The method used in claim 1 uses the cash flow leveraging mechanism to finance each principal only payment. Payments are either directly or indirectly from the cash flow leveraging mechanism.

29. The method used in claim 1 finances accelerated debt pay off from funds that are not felt by the budget while addressing all budgeted items on time an in full until debts are eliminated.

30. The method used in claim 1 uses funds that are not felt by the budget, quickly creates increased disposable income and quickly eliminates debt service payments to allow calculated profit values substantially greater than accelerated debt payment programs that highlight interest cost savings.

31. The method used in claim 1 calculates profits rather than savings by focusing on reducing or eliminating the total number of debt service payments across an entire budget, hence a much more effective and profitable budget (FIG. 5).
